(19) United States
(12) Patent Application Publication
(10) Pub. No.: US 2014/0056622 A1
(43) Pub. Date: Feb. 27, 2014

(54) DEVELOPMENT DEVICE AND IMAGE FORMING APPARATUS INCORPORATING SAME

(71) Applicant: Motohiro USAMI, Kanagawa (JP)

(72) Inventor: Motohiro USAMI, Kanagawa (JP)

(21) Appl. No.: 13/960,125

(22) Filed: Aug. 6, 2013

(30) Foreign Application Priority Data
Aug. 22, 2012 (JP) 2012-183322

(51) Int. Cl. G03G 15/09

(52) U.S. Cl. CPC G03G 15/09
USPC 399/277

(57) ABSTRACT

A developing device to develop a latent image includes a developer bearer including a rotatable, hollow developer supporter to carry two-component developer on a surface thereof, and a stationary magnetic field generator having multiple magnetic poles and disposed inside the hollow developer supporter, and a magnetic field adjuster. The magnetic field generator generates a magnetic flux on the surface of the hollow developer supporter, and the magnetic field adjuster suppresses a maximum value of magnetic flux density in a tangential direction to the surface of the hollow developer supporter from a predetermined value for image formation.

### CROSS-REFERENCE TO RELATED APPLICATION

This patent application is based on and claims priority pursuant to 35 U.S.C. §119 to Japanese Patent Application No. 2012-183322, filed on Aug. 22, 2012 in the Japan Patent Office, the entire disclosure of which is hereby incorporated by reference herein.

### BACKGROUND OF THE INVENTION

1. Technical Field

The present invention generally relates to a developing device to develop with developer electrostatic latent images and an image forming apparatus, such as, a copier, a printer, a facsimile machine, a plotter, or a multifunction peripheral (MFP) including at least two of coping, printing, facsimile transmission, plotting, and scanning capabilities, that includes the developing device.

2. Description of the Background Art

There are developing devices that include a developing roller or developing sleeve, serving as a developer bearer to carry developer. Such developing devices are designed to develop with toner electrostatic latent images formed on a photoreceptor, serving as an image bearer, in a development range where the developing roller faces the photoreceptor, thereby forming toner images on the photoreceptor.

There are two types of developing methods: two-component development employing two-component developer including toner (toner particles) and carrier (carrier particles), and one-component development employing one-component developer consisting essentially of toner. Developing rollers usable in two-component development typically include the developing sleeve serving as the developer bearer and a magnet, serving as a magnetic field generator, disposed inside the developing sleeve. Two-component developer particles are carried on the surface of the developing sleeve and caused to form a magnetic brush. In the development range, toner in the magnetic brush is caused to adhere to the electrostatic latent image formed on the photoreceptor to form a toner image thereon.

Currently, low-temperature image fixing is promoted to reduce energy consumption in image forming apparatuses. Use of toner fusible at a lower temperature (hereinafter “low-temperature fusing toner”) can lower the temperature to which a fixing device is heated, and thus power consumption of a heating member of the fixing device can be reduced.

Lowering the fusing temperature of toner, however, can increase the possibility that toner melts and solidifies in portions other than the fixing device. For example, toner can solidify on the developing roller if toner is kept under hot and humid conditions for a long time. Such conditions are possible, for example, when the image forming apparatus or the developing device is transported by ship, crossing the equator. Causes of toner solidification include, in addition to temperature, the strength of magnetic fields and pressure applied to toner.

As a countermeasure, the magnetic field on the developing roller may be reduced in strength. However, simply weakening the strength of the magnetic field is not sufficient, and the strength of the magnetic field is generally determined in accordance with the amount of toner scooped up to the developing roller, behavior of magnetic brush in the development range, behavior of developer separated from the developing roller, and the like.

Regarding the solidification of toner on the developing roller, various approaches have been tried. For example, JP-2002-108100-A proposes use of electromagnets to change the magnetic field and weaken the magnetic field when the device is left unused for a long time.

The inventor of the present invention recognizes that, to prevent toner solidification while the device is driven, the relation between the surface configuration of the developing roller and properties of carrier particles may be considered without changing the magnetic field. For example, JP-2011-170100-A proposes forming fine grooves in the surface of the developing roller with an average distance between the fine grooves is smaller than a weight mean particle diameter of the carrier particles to prevent toner solidification.

### SUMMARY OF THE INVENTION

In view of the foregoing, one embodiment of the present invention provides a developing device to develop a latent image formed on a latent image bearer. The developing device includes a developer bearer and a magnetic field adjuster. The developer bearer includes a rotatable, hollow developer supporter to carry two-component developer on a surface thereof, and a stationary magnetic field generator having multiple magnetic poles and disposed inside the hollow developer supporter. The magnetic field generator generates a magnetic flux on the surface of the hollow developer supporter, and the magnetic field adjuster suppresses a maximum value of magnetic flux density in a direction tangential to the surface of the hollow developer supporter from a predetermined value for image formation.

Another embodiment provides an image forming apparatus that includes the latent image bearer and the developing device described above.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an end-on axial view of a process cartridge including a development device according to a first embodiment;

FIG. 2A is a exploded perspective view of a magnetic field adjuster;

FIG. 2B is a schematic view of the magnetic field adjuster assembled;

FIG. 3A is a chart of density of a magnetic flux generated by the magnetic field generator according to the first embodiment, in a direction normal to the surface of the developer bearer;

FIG. 3B is a chart of density of the magnetic flux in a direction tangential to the surface of the developer bearer according to the first embodiment;

FIG. 4 is an end-on axial view of a process cartridge including a development device according to a second embodiment;

FIG. 5 is a perspective view of a magnetic field adjuster according to the second embodiment;

FIG. 6A is a chart of density of the magnetic flux generated by the magnetic field generator according to the second embodiment, in a direction normal to the surface of the developer bearer;

FIG. 6B is a chart of density of the magnetic flux in a direction tangential to the surface of the developer bearer according to the second embodiment; and

FIG. 7 is a schematic diagram of an image forming apparatus to which a development device according to an embodiment is installable.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

The embodiments described below concerns solidification of developer on or firm adhesion of developer to a developer bearer. An aim of this specification is to provide a developing device capable of suppressing firm adhesion of developer to the developer bearer at a lower cost in a state in which image development with developer is not performed. Another aim of this specification is to provide an image forming apparatus capable of forming satisfactory images using such a developing device.

According to the study of the inventor of the present invention, firm adhesion of developer tends to occur at positions where developer particles do not stand on end on but lie, and the degree of firm adhesion of developer increases as the magnetic flux density becomes higher.

In view of the foregoing, the present embodiment is designed to suppress the magnetic flux density on the surface of the developer bearer at position where magnetic brush formed by the magnetic force lies, that is, the magnetic flux density on the developer bearer, in a direction tangential to the surface of the developer bearer. In particular, a developing device according to the present embodiment is provided with a magnetic field adjuster to reduce the maximum value of a tangential component of the magnetic flux density on the surface of the developer bearer from the setting for image development.

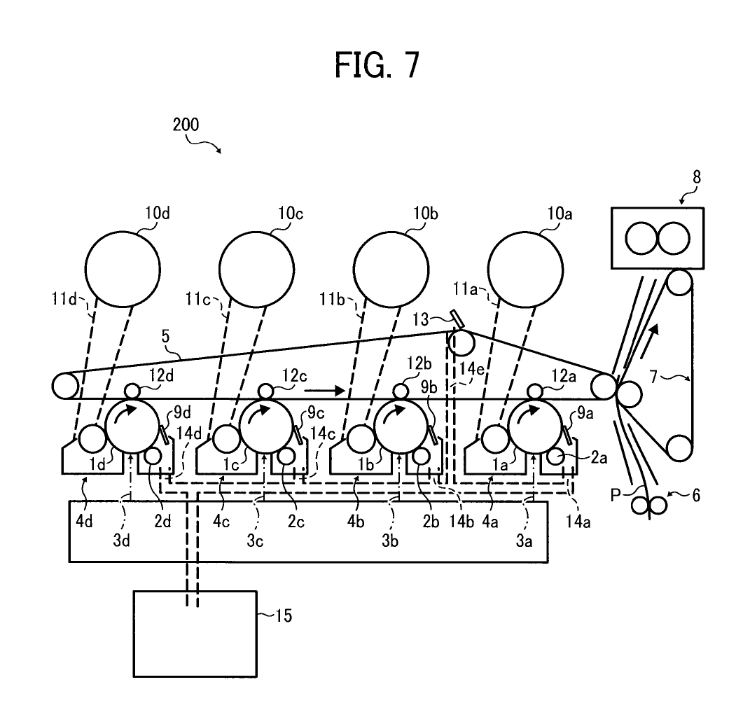

Referring now to the drawings, wherein like reference numerals designate identical or corresponding parts throughout the several views thereof, and particularly to FIG. 7, a multicolor image forming apparatus according to an embodiment of the present invention is described. It is to be noted that the term “cylindrical” used in this specification is not limited to round columns but also includes polygonal prisms.

FIG. 7 illustrates an electrophotographic image forming apparatus 200 according to the present embodiment.

For example, the image forming apparatus 200 employs intermediate image transfer. The image forming apparatus 200 is capable of multicolor image formation using yellow, cyan, magenta, and black toners. The image forming apparatus 200 includes an intermediate transfer belt 5, serving as an intermediate transfer member, stretched around multiple rollers. The image forming apparatus 200 is tandem type, and drum-shaped photoreceptors 1a, 1b, 1c, and 1d, serving as latent image bearers are disposed facing the intermediate transfer belt 5 and arranged in the direction in which the intermediate transfer belt 5 moves. To the photoreceptors 1a, 1b, 1c, and 1d, charging rollers 2a, 2b, 2c, and 2d serving as charging members, developing devices 4a, 4b, 4c, and 4d, and photoreceptor cleaning members 9a, 9b, 9c, and 9d are provided, respectively. Inside the loop of the intermediate transfer belt 5, primary-transfer members 12a, 12b, 12c, and 12d are disposed respectively facing the photoreceptors 1a, 1b, 1c, and 1d, thus forming a primary transfer section. It is to be noted that the suffixes a, b, c, and d attached to reference numerals given to image forming components indicate only that components indicated thereby are used for forming different color images, and hereinafter may be omitted when color discrimination is not necessary.

In the image forming apparatus 200, single color toner images are formed on the respective photoreceptors 1 and primarily transferred therefrom and superimposed one top of another on the intermediate transfer belt 5 sequentially, forming a multicolor toner image. Then, the toner image is secondarily transferred onto a sheet P (recording medium).

Specifically, the charging roller 2 uniformly charges the surface of the photoreceptor 1, and a writing unit directs an exposure beam (i.e., exposure light) 3 thereto, thereby forming a latent image optically. The developing device 4 develops the latent image into a toner image. The toner image on the photoreceptor 1 is transferred onto the intermediate transfer belt 5 primarily by the primary-transfer member 12 disposed on the inner side of the intermediate transfer belt 5. A transfer belt 7 and multiple rollers around which the transfer belt 7 is stretched together form a secondary-transfer section. In the secondary-transfer section, the toner image is secondarily transferred onto the sheet P forwarded by a pair of registration rollers 6. The transfer belt 7 transports the sheet P carrying the toner image to a fixing device 8, where the toner image is fixed on the sheet with heat and pressure. Subsequently, the sheet P is discharged outside the apparatus.

The photoreceptor cleaning member 9 scrapes off toner remaining on the intermediate transfer belt 5 after primary image transfer. Further, residual electrical charges are removed by a discharger as a preparation for subsequent image formation.

The image forming apparatus 200 further includes waste toner collecting channels 14a, 14b, 14c, and 14d and a toner container 15. The respective color toners (i.e., waste toner) removed by the photoreceptor cleaning members 9a, 9b, 9c, and 9d are transported through the toner collecting channels 14a, 14b, 14c, and 14d and collected in the waste toner container 15. Similarly, a cleaning blade 13 scrapes off toner remaining on the intermediate transfer belt 5 after secondary image transfer and toner patterns for process control, and the toner thus removed is collected through a toner collecting channel 14e in the waste toner container 15.

The image forming apparatus 200 further includes toner replenishing devices 10a, 10b, 10c, and 10d to supply toner from toner cartridges to the developing devices 4 and toner hoppers 11a, 11b, 11c, and 11d to store respective color toners supplied by the toner replenishing devices 10a, 10b, 10c, and 10d. The toner hoppers 11a, 11b, 11c, and 11d are positioned on the rear side of an apparatus body.

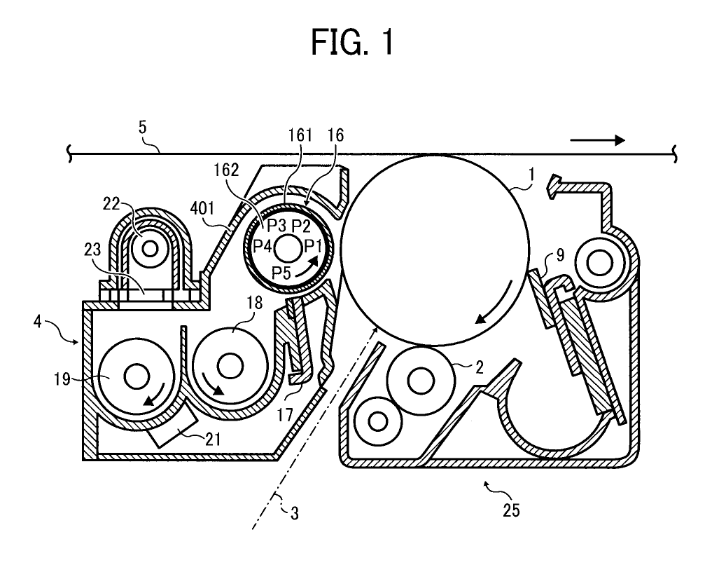

Next, a configuration of the developing device according to the present embodiment is described below with reference to FIG. 1. It is to be noted that the developing devices 4 for the respective colors have a similar configuration except the color of toner used.

In the configuration shown in FIG. 1, for example, the photoreceptor 1 and the developing device 4 can be united together into a process cartridge 25 that is a single modular unit removably mountable in the apparatus body. Alternatively, the photoreceptor 1, the developing device 4, and either or both of the charging roller 2 and the photoreceptor cleaning member 9 can be united together into the process cartridge 25.

The developing device 4 includes a developing roller 16 serving as a developer bearer to supply toner to the electrostatic latent image optically formed on the photoreceptor 1 with the exposure beam 3. The developing roller 16 is partly exposed on the side of the photoreceptor 1 through an opening of a development casing 401 that forms a body of the developing device 4. The developing roller 16 is rotatable. A developer doctor 17 is positioned upstream from a development range of the developing roller 16 in the direction of rotation thereof. The developer doctor 17 is supported by the development casing 401 and can serve as a developer regulator to adjust the amount of developer on the developing roller 16. After the developer doctor 17 adjusts the height (i.e., amount) of toner carried on the developing roller 16, developer is transported to the photoreceptor 1, thus developing the electrostatic latent image thereon into a toner image.

The developing device 4 includes a developer tank that contains two-component developer consisting essentially of toner particles (also simply “toner”) and magnetic carrier particles (also simply “carrier”). As conveying screws 18 and 19 serving as developer conveying members rotate at a similar or identical velocity, developer is circulated inside the developing device 4, and toner and carrier therein are agitated. Thus, developer is frictionally charged. The conveying screw 18 supplies a part of the developer circulated in the developing device 4 to the developing roller 16. The developing roller 16 bears developer magnetically and transports the developer by rotation. A toner density sensor (or toner concentration sensor) 21 is provided beneath the conveying screw 19 to detect the density or concentration of toner inside the developer tank, and a controller of the image forming apparatus 200 adjusts the density or concentration of toner based on the detection by the toner density sensor 21.

The toner replenishing device 10 shown in FIG. 1 includes a toner bottle. When the density of toner in the developer tank is lower than a threshold according to the toner density sensor 21, a toner supply screw 22 is rotated for a time period calculated using a predetermined convention formula, and thus toner inside the toner bottle is transported to a supply inlet 23 formed in the developing device 4. It is to be noted that a toner detector may be provided inside the toner hopper to detect the presence of toner. When the toner detector detects that no (or little) toner is present, a toner supply request is given to the toner replenishing device 10. If the toner detector does not detect the presence of toner even though toner supply is requested a predetermined time period, it is deemed that toner is not present.

### First Embodiment

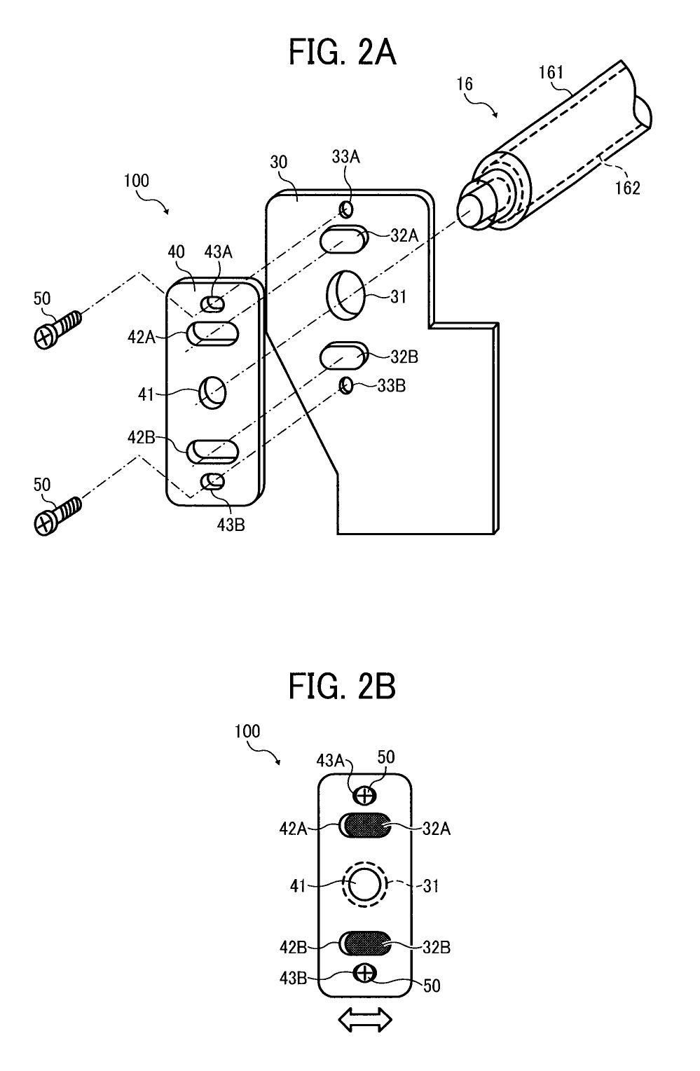

As shown in FIG. 1, the developing roller 16 includes a developing sleeve 161, serving as a hollow, cylindrical developer supporter, and a magnet roller 162, serving as a magnetic field generator, stationary disposed inside the developing sleeve 161. The developing sleeve 161 can be cylindrical and constructed of a nonmagnetic material, and the magnet roller 162 has multiple magnetic poles P1 through P5. The developing device 4 further includes a magnetic field adjuster 100, shown in FIGS. 2A and 2B, to adjust magnetic flux density (or strength) in a direction tangential to the surface of the developing sleeve 161 regarding the magnetic flux generated on the surface of the developing sleeve 161. For example, the magnetic flux density in the tangential direction regarding the magnetic flux on the developing sleeve 161 can be changed between a preset value for image development and at least one of multiple values (in particular, from the value for image formation to a smaller value) for the period during which image development is not performed.

In the developing device 4 according to the present embodiment, at the position facing the photoreceptor 1, the amount of developer carried on the surface of the developing roller 16 per unit area is preferably from 30 mg/cm² to 70 mg/cm², and, more preferably, from 40 mg/cm² to 60 mg/cm².

When the amount of developer carried per unit area is smaller than 30 mg/cm², it is required to enlarge the electrical field applied to a gap (or development nip) between the developing roller 16 and the photoreceptor 1, imposing a disadvantage regarding adhesion of carrier particles to the photoreceptor. By contrast, when the amount of developer carried per unit area is greater than 70 mg/cm², the density of developer filled in the gap between the photoreceptor 1 and the developing roller 16 tends to be higher. Accordingly, developer tends to remain in the gap, thus degrading fluidity of developer. Decreases in the fluidity of developer hinder smooth supply of toner to the electrostatic latent image on the photoreceptor 1, thus making the image density insufficient or uneven.

In the present embodiment, a peripheral velocity Vs of the developing roller 16 divided by a peripheral velocity Vp of the photoreceptor 1 (Vs/Vp) is preferably from 1.5 to 2.5 to attain high-quality images. When the value Vs/Vp is lower than 1.5, developability is lower since the time during which developer passes by the electrostatic latent image becomes shorter. Accordingly, decreases in image density can be noticeable in printing of images having a higher image area ratio. When the value Vs/Vp exceeds 2.5, that is, duration of contact between developer and the electrostatic latent image is longer, the possibility of occurrence of image failure increases. The term “image failure” here includes decreases in image density at the trailing end of solid images, partial absent of toner, and fluctuations in image density on the boundary between a solid image and a halftone image. Partial absent of toner can be noticeable particularly at the trailing end of halftone images. Such phenomena can arise at portion where latent image potentials are different and boundaries of image density where latent image potentials are discontinuous or changes abruptly. The causes include migration of toner in developer passing through the development nip, transient when a layer of developer having capacitance as a derivative moves through different, discontinuous development electrical fields.

In the embodiments of the present invention, for attaining satisfactory coating ratio of carrier with toner and fluidity of toner, it is advantageous that the toner concentration in developer is within a range from 5.0 to 9.0 in weight percent (wt %), and that a mean charge amount Q of developer per unit volume M (Q/M) is within a range from 15 to 60 in microcoulombs per gram in negative direction (−μC/g), more advantageously, from 20 to 40 (−μC/g). When the toner concentration is lower than 5.0 wt %, the unit charge amount Q/M of developer tends to be higher. Accordingly, the potential required to develop the electrostatic latent image can increase, and the operational life of the photoreceptor 1 can be reduced. Additionally, when the unit charge amount Q/M of developer exceeds 60 (−μC/g), the possibility of decreases in image density becomes higher. When the toner concentration is higher than 9.0 wt %, the unit charge amount Q/M of developer tends to decrease. When the unit charge amount Q/M of developer is lower than 15 (−μC/g), the possibility of occurrence of toner scattering increases, increasing the possibility of toner smear in the backgrounds of images. Thus, image quality can be degraded. Therefore, use of developer having a toner concentration within a range from 5.0 to 9.0 in weight percent (wt %) and a mean charge amount Q/M within a range from 15 to 60 in microcoulombs per gram in negative direction (−μC/g) is advantageous in keeping image quality stable for a long time when the particle sizes of carrier and toner are small.

Coverage of toner over carrier, which can be calculated by the following formula, can be 10% to 80% and preferably from 20% to 60%.

Coverage (%)=(Wt/Wc)×(ρc/ρt)×(Dc/Dw)×(1/4)×100

wherein Dc represents the weight average particle size (μm) of carrier, Dw represents the weight average particle size (μm) of toner, Wt represents the weight (g) of toner, Wc represents the weight (g) of carrier, pt represents the true density of toner (g/cm³), and ρc represents the true density of carrier (g/cm³).

The weight average particle size can be calculated based on the particle diameter distribution of particles measured by number (the relation between number frequency and particle size). In this case, the weight average particle size Dw can be expressed by the formula below.

Dw={1/Σ(nD3)}×{Σ(nD4)}

wherein D represents a representative particle size (μm) of particles present in each channel, and n represents the total number of particles present in each channel. The term “channel” used here means the length for equally dividing the particle size range on the particle diameter distribution map, and the length in the present embodiment is 2 μm, for example. The representative particle size of particles in each channel is set to the lower limit of particle size preserved in each channel.

In the present embodiment, toner fusible at lower temperature (low-temperature fusing toner) is used to lower the fixing temperature, thereby reducing power consumption. The low-temperature fusing toner in the present embodiment means toner whose effluence temperature is 90° C. or lower while that of typical toner is about 130° C. The effluence temperature can be lowered by including crystalline polyester in toner composition.

Additionally, toner in the developer usable in the present embodiment preferably has the weight average particle size Dw within a range from 4.0 μm to 8.0 μm and the ratio (Dw/Dn) of weight average particle size Dw to number average particle size Dn not greater than 1.20. While advantageous in enhancing image resolution, reducing the particle size of toner can degrade fluidity and storage stability of toner. When the particle size of toner is smaller than 4.0 μm, the fluidity of developer may be degraded extremely, making it difficult to keep the toner concentration in developer uniform. Additionally, reducing the particle size of toner tends to increase the coverage over carrier. When the coverage is extremely high, contamination of carrier may be accelerated, and scattering of toner may be induced.

Although the fluidity of toner and developer may be increased by increasing the additive to toner, it can cause adverse side effects. Adverse side effects arising from reductions in the particle size of toner can be overcome by equalizing the particle size distribution of toner. Specifically, it is preferable that the ratio of weight average particle size of toner to number average particle size of toner (Dw/Dn) is close to 1, and, when the ratio Dw/Dn is not greater than 1.20, degradation of fluidity can be alleviated and the toner concentration can be equalized even in the case of small-diameter toner. Thus, when the weight average particle size of toner is from 4.0 μm to 8.0 μm and the ratio Dw/Dn is not greater than 1.20, resolution can be enhanced in addition to image density stability, thereby further enhancing image quality. Further, regarding the toner particle size distribution, when the ratio by number of toner particles not larger than 3 μm is limited to 5% or less, improvement in fluidity and storage stability can be remarkable, and satisfactory levels can be attained in supply of toner to the developing device and charge rising properties.

Various methods can be available to measure toner particle size distribution. In the present embodiment, toner particle size distribution is measured using an electrical sensing zone method (the Coulter principle) that involves letting particles to pass through pores. A measuring instrument for the measurement is COULTER COUNTER MODEL TA2 (Beckman Coulter, Inc.), and an interface to output number distribution and volume distribution is connected thereto. The aperture size can be 100 μm, for example. To measure the particle size distribution, disperse toner sample in electrolyte solution to which surfactant is added. Put the dispersed sample into 1 percent NaCl electrolyte, and let electrical current to flow between electrodes on both sides of an aperture of an aperture tube through the electrolyte. Measure the particle size distribution of particles having a particle size from 2 μm to 40 μm based on changes in resistance at that time, and obtain, from a mean distribution, the number average particle size and the weight average particle size.

It is preferable that fluidity improver is added to toner. There are various materials usable as the fluidity improver, and a combination of hydrophobic silica particles and hydrophobic titanium oxide particles is preferable. In particular, when particles of these materials having a mean particle size not greater than 50 nm are used and agitated with toner, static electric force with toner and Van der Waals force can be reduced, thus improving the fluidity of the toner. As a result, charge of developer can be at a desired level, satisfactory image quality can be attained, and residual toner after image transfer can be reduced. Although excelling in environmental stability and image density stability, uses of titanium oxide particles in developer tends to lower charge rising properties of toner. Therefore, degradation of charge rising properties can be significant when the amount of titanium oxide particles added is greater than that of silica particles. However, image quality of images repeatedly reproduced can be reliable, with degradation in charge rising properties and toner scattering inhibited, when the amount of hydrophobic silica particles added is from 0.3 to 1.5 in percent by weight to the weight of toner particles and hydrophobic titanium oxide particles added is 0.2 to 1.2 in percent by weight to the weight of toner particles.

Additionally, performance of toner transfer and image developing can be improved further by the addition of hydrophobic silica particles whose mean particle size is relatively large, from about 80 nm to 140 nm. Image quality improvement can be noticeable particularly in the case of developer including small-diameter toner whose mean particle size is about 7 μm or smaller. Specifically, the particles added (i.e., additive) having a large particle size can function as spacers among toner particles and inhibit toner from coagulating when toner is pressed in image transfer and additives from being buried in the surface of toner particles when the developing device is in idle agitation. As a result, unevenness in density of solid images caused by defective image transfer and aggravation of toner fluidity due to the additives buried can be suppressed, and high-quality images can be produced for a long time.

Carrier particles in the developer usable in the present embodiment preferably have a weight average particle size Dw within a range from 20 μm to 60 μm, more preferably from 20 μm to 40 μm. When the weight average particle size Dw of carrier is greater than 60 μm, magnetic retention on the photoreceptor to keep carrier is strong, and adhesion of carrier is less likely to occur. In this case, however, the surface area of carrier per unit weight is smaller, and scumming or stain on the background can aggravate abruptly when the toner concentration is increased to attain higher image density. Additionally, when the dot diameters of latent images are smaller, fluctuations in dot diameter increase. By contrast, when the weight average particle size Dw is smaller than 20 μm, magnetic moment per carrier particle decreases, and magnetic retention on the developing roller to hold carrier particles decreases. Accordingly, the possibility of adhesion of carrier particles to the photoreceptor can increase.

When a magnetic field of 1,000·(103/4π)A/m is applied, the magnetic moment per carrier particle is 70 A·m²/kg) or lower. If the magnetic moment is higher than that, the magnetic brush tends to become harder, thus leaving the trace on images or making images uneven, rough. The lower limit can be about 50 A·m²/kg although not specifically prescribed. When the magnetic moment is smaller than 50 A·m²/kg, magnetic retention on the developing roller to hold carrier particles decreases, and the possibility of adhesion of carrier particles increases.

The magnetic moment of carrier particles can be measured as follows. Put 1.0 g of carrier particles in a cylindrical sell, and set the cell in a B-H tracer (BHU-60, manufactured by Riken Denshi Co., Ltd.). Gradually increase the strength of magnetic field to 3,000 oersteds (Oe), which can be converted into about 238,700 A/m. Gradually decrease the strength to zero, and then gradually increase the strength of magnetic field in the opposite direction to 3,000 Oe. Further, gradually decrease the strength of magnetic field to zero, and generate a magnetic field in the initial direction. Draw a B-H curve (magnetization curve) in this manner, and calculate the magnetic moment at 1,000 Oe (about 79,580 A/m) based on the B-H curve.

Referring to FIG. 1, the developing sleeve 161 is rotatable around the magnet roller 162. The magnet roller 162 has a main pole P1 positioned facing the photoreceptor 1 and two south poles and two north poles arranged alternately counterclockwise in FIG. 1, given reference characters P2 through P5, respectively. In the direction of rotation of the developing roller 16, the two adjacent poles situated downstream from the position facing the photoreceptor 1 have an identical polarity to remove developer from the developing roller 16.

As shown in FIGS. 2A and 2B, the magnetic field adjuster 100 includes a side plate 30 serving as a first holder to hold the developing sleeve 161 and a planar magnet holder 40 serving as a second holder to hold the magnet roller 162 and fix the position of the magnet roller 162. The relative distance between the developing sleeve 161 and the magnet roller 162 can be adjusted by moving the planar magnet holder 40 relative to the side plate 30. Thus, the side plate 30 and the planar magnet holder 40 together form a shifting unit to move the magnet roller 162 relative to the development sleeve 161.

Specifically, a support hole 31 is formed in the side plate 30. Further, a positioning projection 32A and a screw hole 33A are formed above the support hole 31, and a positioning projection 32B and a screw hole 33B are formed beneath the support hole 31 in FIGS. 2A and 2B. An end of the developing sleeve 161 is rotatably supported by the support hole 31 via a bearing.

A hole 41 is formed in the planar magnet holder 40. A positioning slot 42A and a holding slot 43A are formed above the hole 41, and a positioning slot 42B and a holding slot 43B are formed beneath the hole 41 in FIGS. 2A and 2B. The hole 41, the positioning slots 42A and 42B, and the holding slots 43A and 43B are respectively disposed facing the support hole 31, the positioning projections 32A and 32B, and the screw holes 33A and 33B of the side plate 30. The length of each of the positioning slots 42A and 42B is longer than the length of each of the positioning projections 32A and 32B.

An end of the magnet roller 162 (i.e., a roller-shaped magnet) is fitted in the hole 41. The positioning projections 32A and 32B are inserted into the positioning slots 42A and 42B. Screws 50 inserted in the holding slots 43A and 43B are fitted in the screw holes 33A and 33B, thereby fixing the position of the magnet roller 162. Thus, the screws 50 serve as fasteners to fix the planar magnet holder 40 relative to the side plate 30. To change the position of the magnet roller 162, the screws 50 are loosed, and the planar magnet holder 40 is moved in the longitudinal direction of the positioning slots 42A and 42B. When the screws 50 are tightened, the magnet roller 162 can be fixed at that position.

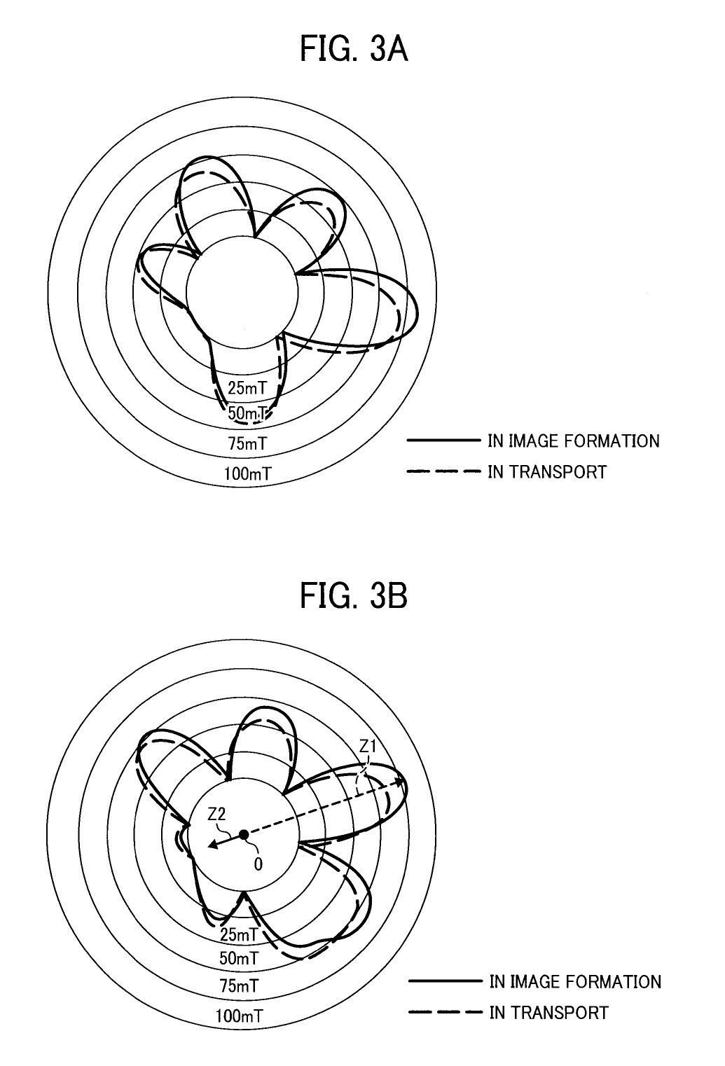

FIGS. 3A and 3B are distribution charts of magnetic flux density on the developing roller 16. FIG. 3A illustrates distribution of magnetic flux density in a direction normal to the surface of the developing roller 16, and FIG. 3B illustrates distribution of magnetic flux density in a direction tangential to the surface of the developing roller 16. In FIGS. 3A and 3B, solid lines represent a magnetic flux density distribution in a state for image formation, that is, for developing latent images with toner, and broken lines represent a magnetic flux density distribution in a state not for forming images, that is, a withdrawal state for, for example, transport of the apparatus or the device (hereinafter “transport of the apparatus”). It is to be noted that the term “transport of the apparatus” includes transport under applicable temperature and humidity conditions and transport under hot and humid conditions.

In FIG. 3B, reference character Z1 represents a direction extending from a center O (i.e., center of axis) of the developing sleeve 161 to a maximum density position at which the magnetic flux density (tangential component) on the developing roller 16 is maximum. The planar magnet holder 40 moves, relative to the side plate 30, in the direction indicated by arrow Z2 opposite the direction Z1. In other words, the positioning slots 42A and 42B, the positioning projections 32A and 32B, and the holding slots 43A and 43B are parallel to the direction indicated by arrows Z1 and Z2.

In the present embodiment, in transport of the apparatus, the position of the magnet roller 162 is shifted in the direction Z2 from the position for image formation so that the magnetic pole corresponding to the maximum density position, where the magnetic flux density in the tangential direction is maximum, is away from the developing sleeve 161. The magnet roller 162 is fixed at that position during transport. In the present embodiment, the magnetic field adjuster 100 enables at least two different degrees of displacement of the magnet roller 162. The term “at least two different degrees of displacement” used here means that the magnet roller 162 is movable to the position for image development, the position for withdrawal state, and one or more other positions between them (e.g., a semi-withdrawal position). In other words, the magnetic field adjuster 100 can shift the magnet roller 162 from the position for image formation to one of multiple different positions relative to the developing sleeve 161.

For example, the semi-withdrawal position can be adopted in the following situation. During transport, the development device can be vibrated depending on transport conditions. In the withdrawal state, the retention to keep developer decreases due to the reduction in the magnetic force of the main development pole, and thus developer may scatter depending on the degree of vibration. If there are only two options, namely, the position for image development and that for withdrawal state, not both but only one of developer solidification and developer scattering can be avoided. By contrast, addition of another option (for semi-withdrawal state) between the position for image development and that for withdrawal state may make it possible to avoid both of developer solidification and developer scattering when temperature and humidity are higher but below the expected level.

When the position of the magnet roller 162 inside the developing sleeve 161 is thus movable from the position for image formation at different degrees, the magnetic flux density (tangential component) on the surface of the developing roller 16 can be reduced. Accordingly, fixation or firm adhesion of toner to the surface of the developing roller 16 can be inhibited at a lower cost by reducing the magnetic flux density (tangential component) on the developer bearer in transport during which the apparatus or the device can be left under high temperature and high humidity conditions for a long time.

In particular, the magnet roller 162 can be shifted relative to the center O in the direction Z2, which is opposite the direction Z1 toward the maximum density position regarding the tangential component of the magnetic flux on the developing sleeve 161. In other words, at the position where the magnetic flux density in the tangential direction is maximum, the magnet roller 162 can be moved away from the surface of the developing sleeve 161, thereby reducing the magnetic flux density on the developing sleeve 161 at that position. Accordingly, solidification of toner on the developing sleeve 161 can be inhibited better. Additionally, satisfactory quality images can be formed by using the developing device 4 in the image forming apparatus.

According to the above-described embodiment, the tangential component of the magnetic flux density on the surface of the developer bearer is variable, and thus the magnetic flux density at a position where developer particles lie is adjustable. Accordingly, when the device is device is not used, in particular, left unused or kept under hot and humid conditions for a long time, the magnetic flux density (in the tangential direction) of the developer bearer can be reduced from the value for image development, and firm adhesion (or solidification) of developer to the developer bearer can be inhibited.

Accordingly, firm adhesion or solidification of developer (toner) on the developing sleeve 161 can be suppressed while the device is not used for a long time. Additionally, the cost for suppressing adhesion of developer to the developing sleeve can be lower, and this configuration is suitable for low-cost apparatuses compared with use of electromagnets to change the magnetic flux density.

### Second Embodiment

Descriptions are given below of a second embodiment in which the configuration of the magnetic field adjuster, to reduce the maximum value of the magnetic flux density (in the tangential direction) on the surface of the developing sleeve 161 from the setting for image development, is different from that in the first embodiment.

The configuration of the second embodiment is similar to that of the first embodiment other than the magnetic field adjuster, and components identical to those of the first embodiment are given identical reference characters, thus omitting descriptions thereof.

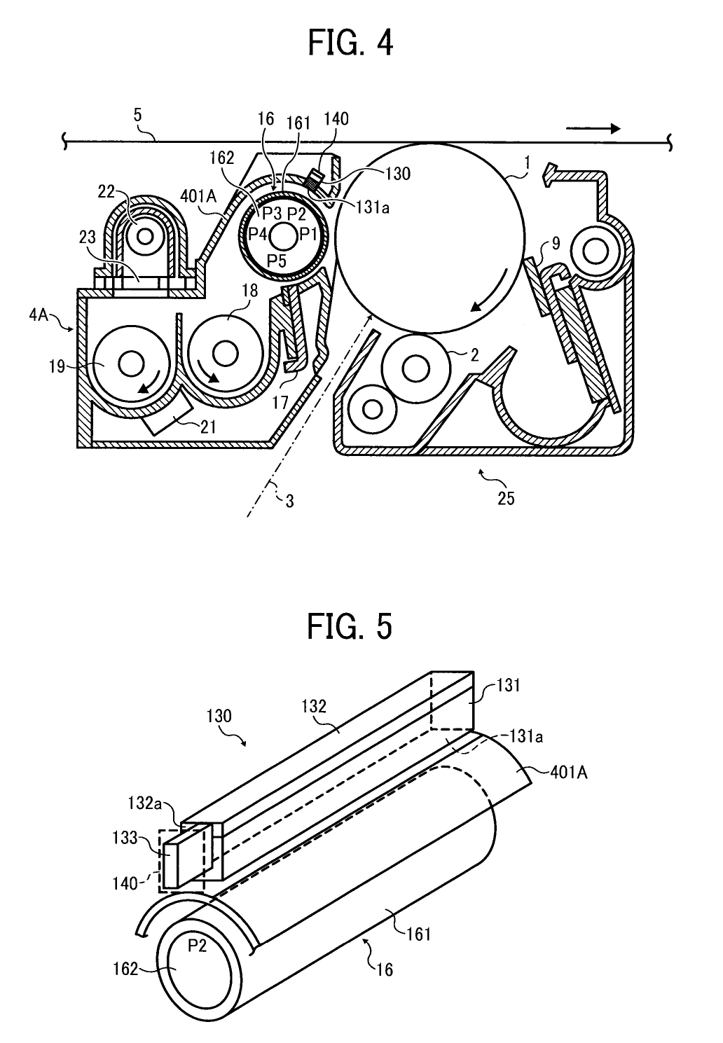

As shown in FIG. 4, a developing device 4A according to the present embodiment includes a magnetic field adjuster 130. The magnetic field adjuster 130 is disposed outside the developing sleeve 161 when the developing device 4A is transported under hot and humid conditions unsuitable for image development, such as transport by ship crossing the equator. Specifically, the magnetic field adjuster 130 is disposed to weaken the magnetic flux density (tangential component) of the magnetic flux formed on the developing sleeve 161 at the position where solidification of developer is likely to occur.

Accordingly, a development casing 401A shown in FIG. 4 includes a mount 140 for the magnetic field adjuster 130.

Referring to FIG. 5, the magnetic field adjuster 130 includes a magnet 131, a magnet support 132, and a handle 133. The magnet 131 serves as a suppressing magnetic field generator to suppress the maximum value of the magnetic flux density in the tangential direction regarding the magnetic flux formed on the developing sleeve 161. The handle 133 is provided, at least, to the magnet support 132. The magnetic field adjuster 130 is removably mountable to the development casing 401A.

In the configuration shown in FIG. 5, the magnet 131 is attached to the magnet support 132 to supplement the strength. The magnet 131 may be bonded to the magnet support 132. The magnet support 132 is formed of a nonmagnetic material having a relatively high strength, such as austenite stainless steel. The handle 133 can be provided to an end 132a of the magnet support 132 to facilitate insertion and removal of the magnetic field adjuster 130 into and from the mount 140. In the present embodiment, the mount 140 is disposed facing the pole P2 on the developing roller 16 as shown in FIG. 4. In FIG. 5, a face 131a of the magnet 131 is opposed to the surface of the developing roller 16 (i.e., developing sleeve 161) and hereinafter referred to as “opposed face 131a”. The mount 140 is positioned such that the opposed face 131a can be about 3 mm away from the surface of the developing roller 16. The magnet 131 can be about 3 mm in width and about 3 mm in thickness. The magnet 131 can be a magnet of about 180 mT, and the opposed face 131a facing the developing roller 16 has a polarity opposite that of the pole P2.

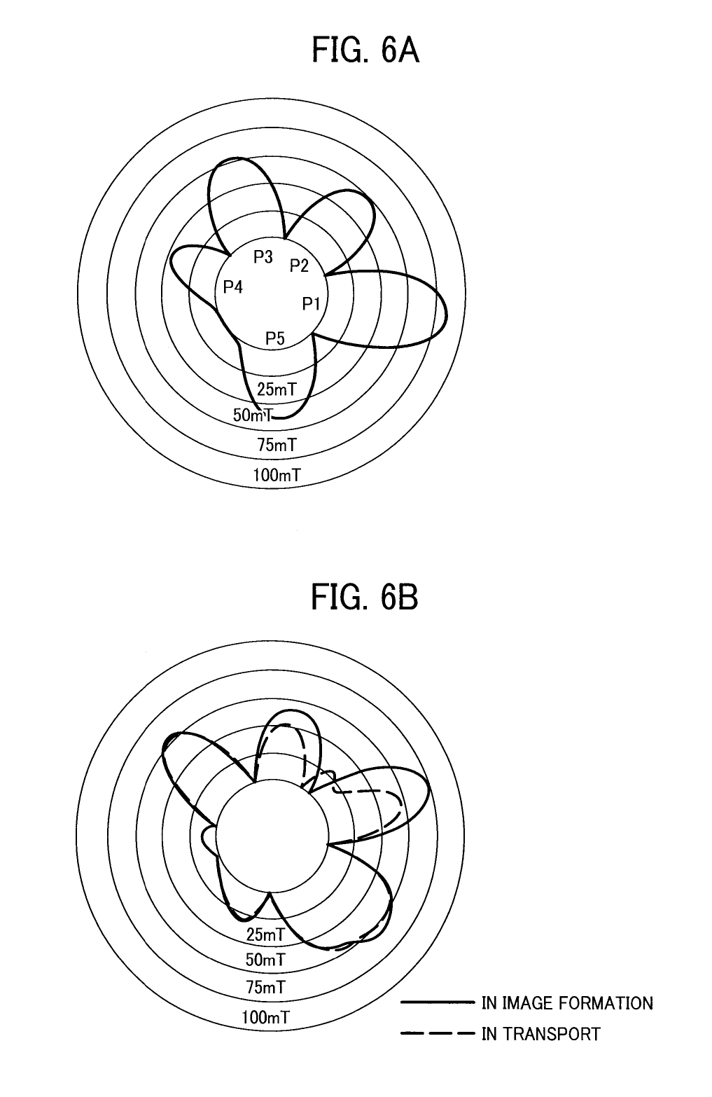

FIGS. 6A and 6B illustrate differences in magnetic flux density on the developing roller 16, caused by the presence of the magnetic field adjuster 130. FIG. 6A is a distribution chart of the magnetic flux density in the direction normal to the surface of the developing roller 16 in the state for image formation (image development) without the magnet 131. FIG. 6B is a distribution chart of the magnetic flux in a direction tangential to the surface of the developing roller 16. The solid line represents a magnetic flux density distribution in image formation without the magnet 131, and broken lines represent a magnetic flux density distribution in a state in which the magnet 131 is provided for transport.

As shown in FIG. 6B, the magnetic flux density in the tangential direction differs depending on the presence of the magnet 131. The magnet 131 thus disposed can reduce the magnetic flux density on the developing sleeve 161 at a position where developer particles lie thereon and are densely present, that is, the magnetic flux density in the tangential direction. Therefore, fixation or firm adhesion of toner to the surface of the developing roller 16 can be inhibited by disposing the magnet 131 in the mount 140 in transport during which the apparatus can be kept in hot and humid environments for a long time.

Additionally, since the roller-shaped magnet, namely, the magnet roller 162, is provided inside the developing roller 16, disposing the magnetic field adjuster 130 outside the developing sleeve 161 can be advantageous in that the arrangement can be easier, limitations in layout can be smaller, and low-cost components can be used.

Since the magnetic field adjuster 130 is removably mountable in the development casing 401A, disassembling the developing device 4A is not necessary to reduce the magnetic flux density. Thus, the developing device 4A can be kept as is after operation is confirmed. That is, it is preferable that the magnetic field adjuster 130 be disposed outside the developing roller 16 and adjacent to the position where the magnetic flux density in the tangential direction is maximum. The handle 133 provided to the magnetic field adjuster 130 can make it easier for users or operators to mount and remove the magnetic field adjuster 130 from the developing device 4A.

Additionally, the second embodiment can attain effects similar to those attained by the first embodiment.

It is to be noted that, although the full-color image forming apparatus using four color toners is exemplified in the above-described embodiments, configurations provided with the magnetic field adjuster 100 or 130 are not limited thereto but may be single color image forming apparatuses, for example.

Additionally, although the magnetic field adjusters 100 and 130 are mountable in the developing devices 4 and 4A incorporated in the process cartridges 25 in the above-described embodiments, alternatively, the magnetic field adjusters 100 and 130 can be mounted in independent developing devices.

It will be understood that if an element or layer is referred to as being “on,” “against,” “connected to” or “coupled to” another element or layer, then it can be directly on, against, connected, or coupled to the other element or layer, or intervening elements or layers may be present. In contrast, if an element is referred to as being “directly on”, “directly connected to” or “directly coupled to” another element or layer, then there are no intervening elements or layers present.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed above could be termed a second element, component, region, layer or section without departing from the teachings of the present invention.

Numerous additional modifications and variations are possible in light of the above teachings. It is therefore to be understood that, within the scope of the appended claims, the disclosure of this patent specification may be practiced otherwise than as specifically described herein.

What is claimed is:

1. A developing device to develop a latent image, comprising:
a developer bearer including:
a rotatable, hollow developer supporter to carry two-component developer on a surface thereof, and
a stationary magnetic field generator to generate a magnetic flux on the surface of the hollow developer supporter, the magnetic field generator having multiple magnetic poles and disposed inside the hollow developer supporter; and
a magnetic field adjuster to suppress a maximum value of magnetic flux density in a tangential direction to the surface of the hollow developer supporter from a predetermined value for image formation.

2. The developing device according to claim 1, wherein the magnetic field adjuster shifts the magnetic field generator from a position for image formation to one of multiple different positions relative to the hollow developer supporter.

3. The developing device according to claim 2, wherein the magnetic field adjuster comprises:
a first holder to rotatably hold an end portion of the hollow developer supporter;
a second holder to hold an end portion of the magnetic field generator; and
a fastener to fix a position of the second holder relative to the first holder.

4. The development device according to claim 2, wherein the hollow developer supporter is cylindrical and rotatable around an axis thereof, and
the magnetic field adjuster moves the magnetic field generator in a direction opposite a direction extending from a center of the axis of the hollow developer supporter to a position where the magnetic flux density in the tangential direction is maximum.

5. The development device according to claim 1, wherein the magnetic field adjuster comprises a suppressing magnetic field generator to suppress the maximum value of the magnetic flux density in the tangential direction to the surface of the hollow developer supporter.

6. The development device according to claim 5, wherein the magnetic field adjuster is disposed outside the hollow developer supporter.

7. The development device according to claim 5, further comprising a mount to which the magnetic field adjuster is mounted,
wherein the magnetic field adjuster is removably mountable in the mount, and
the magnetic field adjuster further includes a support to support the suppressing magnetic field generator, and a handle provided at least to the support.

8. An image forming apparatus comprising:
a latent image bearer on which a latent image is formed; and
a developing device to develop the latent image and including:
a developer bearer including a rotatable, hollow developer supporter to carry two-component developer on a surface thereof, and a stationary magnetic field generator to generate a magnetic flux on the surface of the hollow developer supporter, the magnetic field generator having multiple magnetic poles and disposed inside the hollow developer supporter; and
a magnetic field adjuster to suppress a maximum value of magnetic flux density in a tangential direction to the surface of the hollow developer supporter from a predetermined value for image formation.
